(19) United States
(12) Patent Application Publication
(10) Pub. No.: US 2004/0103180 A1
(43) Pub. Date: May 27, 2004

(54) Method, apparatus and program product for server mangement

(75) Inventors: Rodney Hugh Brown, Cary, NC (US); Gregory William Dake, Durham, NC (US); Jeffery M. Franke, Apex, NC (US); Donald Eugene Johnson, Apex, NC (US); Edward Joseph Klodnicki, Durham, NC (US); Carl Anthony Morrell, Cary, NC (US); Chetan Dhirubhai Patel, Cary, NC (US); Michael Scott Rollins, Durham, NC (US); William Bradley Schwartz, Apex, NC (US); David R. Woodham, Raleigh, NC (US)

Correspondence Address: IBM Corporation, Intellectual Property Law Dept. 9CCA/B002, P.O. Box 12195, Res. Tri. Park, NC, 27709, US

(73) Assignee: International Business Machines Corporation, Armonk, NY (US)

(21) Appl. No.: 10/306,304

(22) Filed: Nov. 27, 2002

(51) Int. Cl. G06F 15/173

(52) U.S. Cl. 709/223

(57) ABSTRACT

Signals to a management module are generated on an occurrence of an event affecting one of a plurality of server blades housed in a common chassis with the management module and aggregated in the management module. Signaling in accordance with this invention may be originated at a number of levels of operation of information handling systems, and distinction can be drawn between an occurrence requiring prompt attention from an operator—an alert—and occurrences where such prompt action is unnecessary. Occurrences signaled are logged for possible later review, and such a log will, in the contemplation of this invention, contain events related to a number of server blades.

### FIELD AND BACKGROUND OF INVENTION

This invention relates to the management of information handling systems and particularly to the management of server systems.

One way to classify information handling systems is to distinguish between workstations and servers. Workstations, which may be desktop systems, notebook systems, PDAs or the like, are typically used by an individual operator to perform tasks which are at least somewhat individualized, such as processing documents, spreadsheets or the like. Server systems typically are connected with workstations and with other servers through networks, either wired, wireless or mixed. Server systems provide support for tasks undertaken on workstations, as by storing or moving large volumes of data, handling mail and other transactions. The respective functions of workstations and server systems are well known to persons of skill in the arts of information technology and extended discussion here is unnecessary.

Heretofore, an information handling system functioning as a sever system frequently was self contained within an appropriate housing. However, as demands on server systems have increased with the increasing spread of networks and the services available through networks, alternate technologies have been proposed to improve server system availabilities. One such proposal is a format known as a blade server. A blade server provides functionality comparable to or beyond that previously available in a “free standing” or self contained server by housing a plurality of information handling systems in a compact space and a common housing. Each server system is configured to be present in a compact package known as a blade which can be inserted in a chassis along with a number of other blades. At least some services for the blades, typically power supply, are consolidated so that the services can be shared among the blades housed in common.

Driven by customers who demand that information systems be scalable, available, and efficiently managed, the design of servers has continued to evolve. Recently, with the move to consolidated data centers, standalone pedestal servers with attached storage have been giving way to rack-optimized servers in order to increase server density and better utilize valuable floor space. The blade architecture represents the next step in this server evolution: a shift to servers packaged as single boards and designed to be housed in chassis that provide access to all shared services.

A server blade has been defined as an inclusive computing system that includes processors and memory on a single board. Most notably, power, cooling, network access, and storage services are not necessarily contained on the server blade. The necessary resources, which can be shared among a collection of blades, are accessed through a connection plane of the chassis; that is, the power and bus connections are a part of the cabinet that houses a collection of the blades. Blades are easily installed and removed and are smaller than rack-optimized servers. Blades may be general-purpose servers, or they may be tailored and preconfigured for specific data center needs (e.g., as security blades with firewall, virtual private network [VPN], and intrusion detection software preinstalled).

It has been known and practiced for some time in management of networks that information handling devices participating in the network can be managed from a common console through the use of technology such as the Simple Network Management Protocol or SNMP. SNMP, which has been adopted as an industry standard, contemplates that devices in a network will generate signals indicate of the states of the devices and thus report those states, such as “power on”, to the network management console. Such signaling permits a network administrator to more readily manage the network by assuring that the occurrence of significant events is noticed and any necessary corrective action is taken.

### SUMMARY OF THE INVENTION

With the foregoing discussion in mind, it is a purpose of this invention to facilitate the management of blade server information handling systems. In realizing this purpose, provision is made for signaling to a management module an occurrence of an event affecting one of a plurality of servers housed in a common chassis with the management module and aggregating in the management module occurrences of events affecting each of the plurality of servers.

Signaling in accordance with this invention may be originated at a number of levels of operation of the information handling systems, and distinction can be drawn between an occurrence requiring prompt attention from an operator—an alert—and occurrences where such prompt action is unnecessary. Occurrences signaled are logged for possible later review, and such a log will, in the contemplation of this invention, contain events related to a number of server blades. By providing this functionality and method, the information handling system is rendered free of any requirement that each blade server be enabled to create and maintain its own individual log of event occurrences.

### BRIEF DESCRIPTION OF DRAWINGS

Some of the purposes of the invention having been stated, others will appear as the description proceeds, when taken in connection with the accompanying drawings, in which:

FIG. 1 is an exploded perspective representation of a blade sever apparatus as contemplated by this invention;

FIG. 2 is a diagrammatic representation of the signaling which occurs in implementation of this invention in the apparatus of FIG. 1; and

FIG. 3 is a schematic representation of a computer readable medium bearing programs effective when executing on a processor to perform the steps o FIG. 2.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

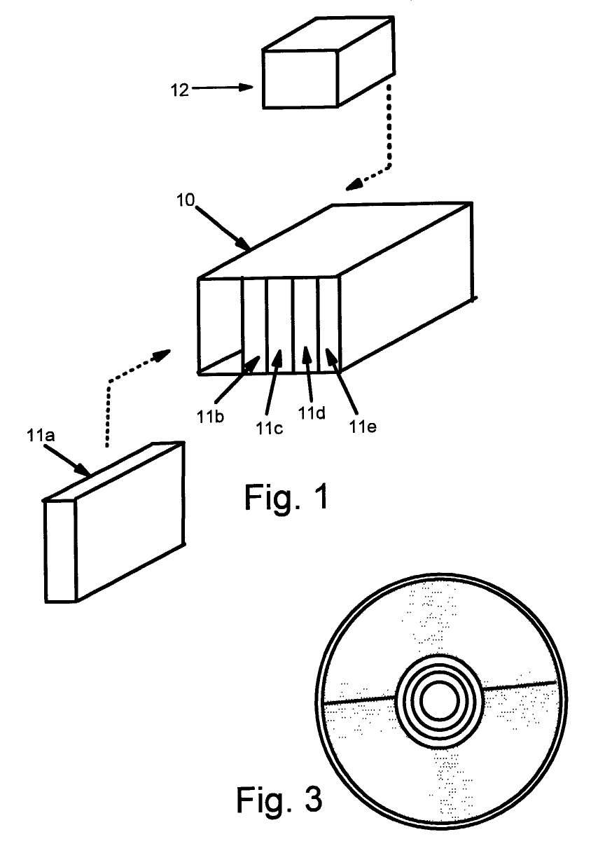

Referring now more particularly to the drawings, FIG. 1 illustrates an exemplary blade server information handling apparatus. While the view is simplified and certain elements to be here described are not visible, the apparatus is shown to have a chassis 10 in which are housed a plurality of blades 11. One blade 11a is shown as withdrawn from the chassis 10, with an indication that the blade 11a may be inserted into the chassis. The chassis 10 also houses a management module 12, shown for clarity as removed from the chassis with an indication that the module 12 may be inserted into the chassis. In use, the blades 11 and management module 12 are mounted within the common housing of the chassis 10 and are interconnected therewithin by a midplane which is obscured from view by the elements which are shown. While this organization of the information handling apparatus has novelty apart from the invention here described, and is described more fully elsewhere, it is to be understood as providing the context in which the present invention is implemented. This general organization may be varied, as by providing the management module as one of the blades and using a backplane as distinguished from a midplane, all while adopting the invention here disclosed.

Each blade 11 bears a general purpose central processing unit (CPU) such as an Intel X86 based processor or a PowerPC processor. Each blade also bears a service processor, which is a lower function processor employed for monitoring and signaling purposes as described hereinafter. Each blade is provisioned with program instructions which, when executing on the processors, perform a power on self test (POST), perform diagnostics to determine the operating state of the blade, and load a basic input output system (BIOS) before loading an operating system (OS). The provision of POST, diagnostics, and BIOS is well known to persons of skill in the design and use of information handling systems of the general types here described. That is, POST, diagnostic, and BIOS programs have been provided in server systems of the earlier, free standing, types and such technology is employed in the blade servers here described.

The management module 12 communicates with the plurality of blades 11 housed in the chassis 10. The management module 12 has a CPU capable of executing programs and access to memory suitable for storing data, such as NVRAM, ROM, a hard drive or the like. The management module also has capability for communication over a network with other information handling system devices.

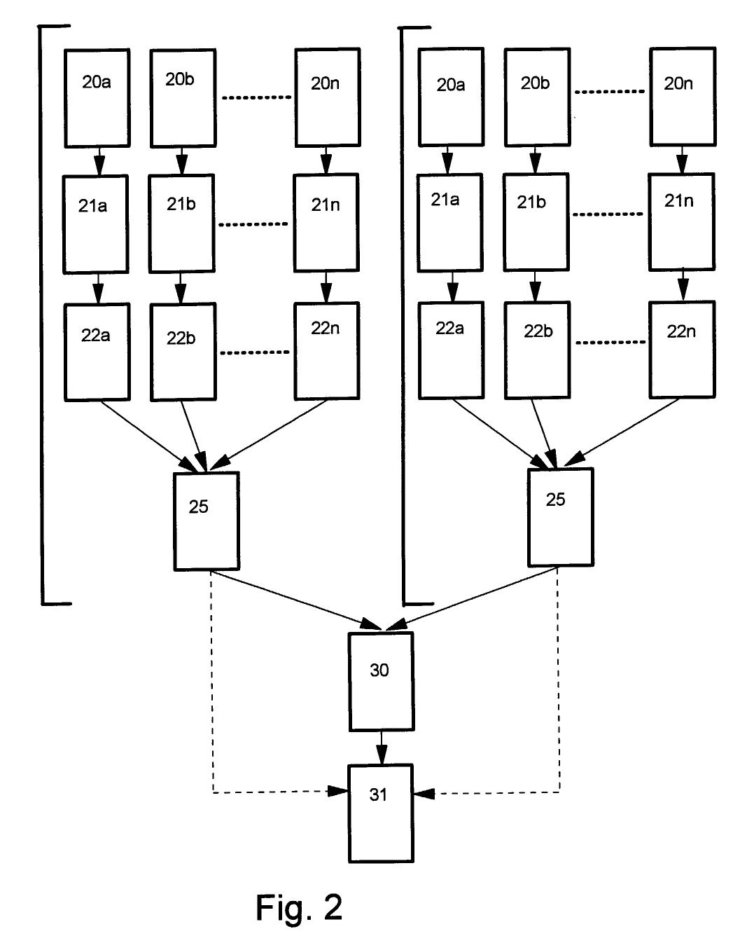

Turning now to FIG. 2, what is there illustrated is the flow of information among a plurality of blade server systems and certain management resources in accordance with this invention. Elongate bracket lines extend along the elements of an apparatus housed in a common chassis as is illustrated in FIG. 1. Two such apparatus are illustrated schematically, one to the left margin of the Figure and one to the right. Common elements are identified by common reference numerals.

Management information flow may begin with signaling to the management module 12 an occurrence of an event affecting one of the plurality of servers, with such a signal originating from the execution of the diagnostic program 20a accessible to the one blade. Such diagnostic programs are accessible to each of the plurality of blades 11a, 11b, 11c, et seq. housed in the common housing 10, as indicated by the parallel data flows 20b through 20n in FIG. 2. The event may be, for example only, one of a set which may include Self Test Result Failed, System Management: Failed, I2C Bus Test Results Failed, The power-on password has become invalid.

The management information data flow will continue with any signal of an event affecting a particular blade as developed from execution of the blade BIOS 21a. As indicated above, a BIOS program is accessible to each of the plurality of blades 11a, 11b, 11c, et seq. housed in the common housing 10, as indicated by the parallel data flows 21b through 21n in FIG. 2. The event may be, for example only, one of a set which may include Voltage Fault, CPU Fault, Temperature Fault, Blade Removed or Blade Inserted.

Communications originating from execution of the diagnostic and BIOS programs will be routed through a service processor provided on the blade 11a et seq. The service processor itself may originate management information signals as indicated at 22a et seq. in FIG. 2 in addition to signals passed through the operation of the diagnostic and BIOS programs. Certain blade system monitoring functions may be reported directly to the service processor, such as power states, mismatches between the blade capabilities and those expected of a blade in the insertion position or slot, and CPU failures.

Persons familiar with the various details of internal management of an information handling system such as a server will be familiar with the general and specific types of system management information which has been and can be developed and reported as contemplated by this invention, and the types here specifically mentioned are intended to be illustrative only and neither exhaustive nor necessarily complete.

As indicated in FIG. 2, management information data flowing from blades 11a et seq. as described above reaches the management module 12 as indicated at 25. The information from a plurality of blades, if such are mounted, is aggregated at the management module. Thus, events possibly affecting the performance of all blades housed in the common housing is aggregated at the management module level. This reduces and simplifies the reporting structure and relieves the blades themselves of the necessity of having or providing storage capability for the management information. Instead, the events are reported and passed on as they occur and further management reporting is moved to a different level of the information handling system.

Management information for the chassis 10 may be reported from the management module on two alternate paths, indicated in FIG. 2. On one path, data flows from the management module 12 to a system administrator or management director level 30 where information may be aggregated over several chassis. That is, blades mounted in two or more different chassis, only two of which are shown in FIG. 2, may have events affecting their performance aggregated at the management director level. A system administration monitor or management director program may execute on a remote management server and receive information through a management network where communication follows a widely accepted protocol such as TCP/IP. Information aggregated at the management director server may then be displayed to a network administrator or other user at step 31. Alternatively, the management module may report directly to the user display 31 using a network connection and TCP/IP or the like. In the latter case, only information related to the single chassis will be displayed. Obviously, where a data center may have a plurality of blade server chassis, aggregating management information across the plurality of chassis will be beneficial.

In all the circumstances described hereinabove, it is desirable to distinguish among signaled occurrences of events requiring prompt operator attention and other events which are less urgent in nature. As to more urgent events, the present invention contemplates generating an alert upon the occurrence of an event requiring prompt operator attention and bringing that alert to the attention of a system administrator or other operator as by displaying a generated alert.

In any event, the present invention contemplates that a log will be maintained of all reported events. That log may be displayed either selectively as requested by an operator or, if so configured, at all times. At the option of the operator, the event log may be filtered to select only certain events or classes of events for recordation in the log and/or display.

FIG. 3 illustrates a computer readable medium which, in accordance with this invention, bears computer executable programs effective to cause server, blades and supporting management modules and system administrator monitors to perform as here described.

In the drawings and specifications there has been set forth a preferred embodiment of the invention and, although specific terms are used, the description thus given uses terminology in a generic and descriptive sense only and not for purposes of limitation.

What is claimed is:

1. A method comprising the steps of:
housing a plurality of information handling system servers and a management module within a common chassis;
signaling to the management module an occurrence of an event affecting one of the plurality of servers; and
aggregating in the management module occurrences of events affecting each of the plurality of servers.

2. A method according to claim 1 further comprising the step of:
providing in each of the information handling system servers a diagnostic program effective when executing to detect and signal occurrences of events affecting the respective server.

3. A method according to claim 1 further comprising the step of:
providing in each of the information handling system servers a basic input/output service (BIOS) program effective when executing to detect and signal occurrences of events affecting the respective server.

4. A method according to claim 1 further comprising the step of:
providing in each of the information handling system servers a service processor effective when executing programs to detect and signal occurrences of events affecting the respective server and to receive and transmit signaled occurrences communicated thereto.

5. A method according to claim 1 further comprising the steps of:
providing a system administration monitor communicating with the management module;
signaling to the system administration monitor occurrences of events affecting the management module;
transmitting to the system administration monitor signaled occurrences of events affecting servers aggregated in the management module; and
aggregating in the system administration monitor occurrences of events affecting the management module and each of the plurality of servers.

6. A method according to claim 1 further comprising the steps of:
distinguishing among signaled occurrences of events requiring prompt operator attention and other events; and
generating an alert upon the occurrence of an event requiring prompt operator attention.

7. A method according to claim 6 further comprising the step of displaying to an operator a generated alert.

8. A method according to claim 1 further comprising the step of maintaining a log of all signaled events.

9. A method according to claim 8 further comprising the step of selectively displaying to an operator the log of all signaled events.

10. Apparatus comprising:
a chassis;
a plurality of information handling system blade servers housed in said chassis;
a management module housed in said chassis and operatively communicating with said plurality of blade servers; and
program instructions stored accessible to said blade servers and said management module and effective when executing to:
signal to said management module an occurrence of an event affecting one of said plurality of servers; and
aggregate in said management module occurrences of events affecting each of said plurality of servers.

11. Apparatus according to claim 10 wherein said program instructions comprise for each of said blade servers a diagnostic program effective when executing to detect and signal occurrences of events affecting the respective server.

12. A method according to claim 10 wherein said program instructions comprise for each of said blade servers a basic input/output system (BIOS) program effective when executing to detect and signal occurrences of events affecting the respective server.

13. Apparatus according to claim 10 wherein each of said blade servers further comprises a service processor effective when executing said program instructions to detect and signal occurrences of events affecting the respective server and to receive and transmit signaled occurrences communicated thereto.

14. Apparatus according to claim 10 further comprising a system administration monitor operatively communicating with said management module, said management module and said system administration monitor being effective when executing said program instructions to:
signal to said system administration monitor occurrences of events affecting said management module;
transmit to said system administration monitor signaled occurrences of events affecting servers aggregated in said management module; and
aggregate in said system administration monitor occurrences of events affecting said management module and each of the plurality of servers.

15. Apparatus according to claim 10 wherein said management module and said system administration monitor when executing said program instructions:
distinguish among signaled occurrences of events requiring prompt operator attention and other events; and
generate an alert upon the occurrence of an event requiring prompt operator attention.

16. Apparatus according to claim 15 wherein said management module and said system administration monitor when executing said program instructions display to an operator a generated alert.

17. Apparatus according to claim 10 wherein said management module and said system administration monitor when executing said program instructions maintain a log of all signaled events.

18. Apparatus according to claim 17 wherein said management module and said system administration monitor when executing said program instructions selectively display to an operator the log of all signaled events.

19. A program product comprising:
A computer readable medium; and
program instructions stored on said medium accessibly to an information handling system an effective when executing to:
signal to a management module an occurrence of an event affecting one of a plurality of servers housed in a common chassis with the management module; and
aggregate in the management module occurrences of events affecting each of the plurality of servers.

20. A program product according to claim 19 wherein said program instructions comprise for each of said blade servers a diagnostic program effective when executing to detect and signal occurrences of events affecting the respective server.

21. A program product according to claim 19 wherein said program instructions comprise for each of said blade servers a basic input/output system (BIOS) program effective when executing to detect and signal occurrences of events affecting the respective server.

22. A program product according to claim 19 wherein said program instructions when executing cause a service processor present on each of said blade servers to be effective when executing said program instructions to detect and signal occurrences of events affecting the respective server and to receive and transmit signaled occurrences communicated thereto.

23. A program product according to claim 19 wherein said program instructions when executing cause a system administration monitor operatively communicating with a management module to cooperate with the management module to:
signal to the system administration monitor occurrences of events affecting the management module;
transmit to the system administration monitor signaled occurrences of events affecting servers aggregated in the management module; and
aggregate in the system administration monitor occurrences of events affecting the management module and each of the plurality of servers.

24. A program product according to claim 19 wherein said program instructions when executing cause a system administration monitor operatively communicating with a management module to cooperate with the management module to:
distinguish among signaled occurrences of events requiring prompt operator attention and other events; and
generate an alert upon the occurrence of an event requiring prompt operator attention.

25. A program product according to claim 24 wherein said program instructions when executing cause the management module and system administration monitor to display to an operator a generated alert.

26. A program product according to claim 19 wherein said program instructions when executing cause the management module and system administration monitor to maintain a log of all signaled events.

27. A program product according to claim 26 wherein said program instructions when executing cause the management module and system administration monitor to selectively display to an operator the log of all signaled events.
